(19) United States
(12) Patent Application Publication
(10) Pub. No.: US 2024/0234852 A1
(43) Pub. Date: Jul. 11, 2024

(54) POWER STATION HAVING MULTIPLE CHARGING SYSTEMS

(71) Applicant: Bollinger Industries, Inc., Roanoke, TX (US)

(72) Inventors: Mike Silva, Amston, CT (US); Clark McCune, Roanoke, TX (US); Chris Barley, Roanoke, TX (US); Todd Marcucci, Mansfield, TX (US)

(21) Appl. No.: 18/613,233

(22) Filed: Mar. 22, 2024

Related U.S. Application Data
(63) Continuation-in-part of application No. 17/524,656, filed on Nov. 11, 2021.
(60) Provisional application No. 63/112,621, filed on Nov. 11, 2020.

(51) Int. Cl. H01M 10/627; B60L 53/51; B60L 53/52; B60L 53/53; H01M 10/0525; H02J 7/00; H02J 7/35

(52) U.S. Cl. CPC H01M 10/627; B60L 53/51; B60L 53/52; B60L 53/53; H01M 10/0525; H02J 7/00034; H02J 7/0025; H02J 7/0048; H02J 7/00712; H02J 7/35; H02J 2207/20; H02J 2207/30; H02J 2207/40; H02J 2300/10; H02J 2300/24; H02J 2300/28; H02J 2300/40

(57) ABSTRACT

A power station system is described. The power station system has an energy collector, an energy generator, an energy storage and an output port. A controller for the power station system is configured to determine input power based on energy collected by the energy collector and energy generated by the energy generator, to determine output power based on the energy provided to the energy output connection and to control the energy generator based on the input power and the output power. The controller can turn off the energy generator in response to the energy storage exceeding a threshold percentage of capacity. The controller may also turn on the energy generator in response to the energy storage being less than the threshold percentage of capacity.

### CROSS-REFERENCE TO RELATED APPLICATIONS

This application is a continuation-in-part of U.S. application Ser. No. 17/524,656, filed on Nov. 11, 2021, which claims priority to U.S. Provisional Application No. 63/112,621, filed on Nov. 11, 2020, each of which is hereby incorporated by reference herein in its entirety.

### FIELD OF THE INVENTION

Various embodiments of the present invention relate generally to power station systems, methods, and devices and, more specifically, relate to power station devices which can be charged in a number of different ways.

### BACKGROUND OF THE INVENTION

This section is intended to provide a background or context. The description may include concepts that may be pursued, but have not necessarily been previously conceived or pursued. Unless indicated otherwise, what is described in this section is not deemed prior art to the description and claims and is not admitted to be prior art by inclusion in this section.

Generating energy, especially on an individual consumer level, can be done using various generators. These include gas generators and solar generators (or collectors). Solar generators rely on presence of sun and can be impacted by the time of day and weather. Additionally, the storage size of the battery limits how much energy may be collected. On the other hand, gas depends on fuel tank capacity and availability of fuel.

In view of the foregoing, there is a need for power station systems to combine the benefits of both gas generators and solar generators in order to overcome some of their drawbacks.

### SUMMARY OF THE INVENTION

The below summary is merely representative and non-limiting.

The above problems are overcome, and other advantages may be realized, by the use of the embodiments.

In a first aspect, an embodiment provides a power station system. The power station system includes one or more energy collector configured to collect energy from an associated ambient source, e.g., a solar panel array configured to capture energy from sunlight. The power station system also includes one or more energy generators configured to create energy, e.g., propane generators. An energy storage module is provided to store energy from the one or more energy collectors and the one or more energy generators and one or more output connections provide energy, e.g., an AC outlet. The power station system has a controller configured to determine input power based on energy collected by the one or more energy collectors and energy generated by the one or more energy generators. The controller can determine output power based on the energy provided to the one or more energy output connections and control the one or more energy generators based on the input power and the output power.

In a further aspect, an embodiment provides a controller for a power station system. The power station system has at least one energy collector, at least one energy generator, an energy storage and at least one output port. The controller includes at least one processor; and at least one memory storing computer program code. The at least one memory and the computer program code are configured to, with the at least one processor, cause the controller to determine input power based on energy collected by the at least one energy collector and energy generated by the at least one energy generator, to determine output power based on the energy provided to the at least one energy output connection and to control the at least one energy generator based on the input power and the output power.

### BRIEF DESCRIPTION OF THE DRAWINGS

Aspects of the described embodiments are more evident in the following description, when read in conjunction with the attached Figures.

FIG. 1 schematically illustrates a power station and charging.

FIG. 2 shows a flowchart of controlling the power station input/output power system.

### DETAILED DESCRIPTION OF EMBODIMENTS OF THE INVENTION

Various embodiments provide a modular or stand-alone power station. The power station contains an internal battery capacity of a certain size (Wh capacity) and can be charged in a number of different ways. In some embodiments, the power station can be charged via the use of one or more solar panels. The solar panels can vary in size and output which can vary the charge speed of the power station. During normal power station use, the internal battery can be discharged when one or more devices are connected to the power station output ports (e.g., AC outputs, DC outputs, USB outputs, etc.). The rate of discharge can vary based on the type and quantity of devices connected.

The power station provides the ability to be charged and discharged simultaneously. The simultaneous charging of the power station during use allows for a longer run-time for connected devices. Energy collectors, such as solar panels, allow the power station to be charged using ambient sources. For example, when solar panels are connected and placed in direct sunlight, a hydro collector is connected and placed in moving water or a wind turbine is connected and placed in the wind.

However, the charging speed from the solar panels can be highly dependent on the weather, solar angle and solar radiation. This can limit how quickly the power station can recharge the internal battery capacity (for continuous use).

A hybrid solar/propane system can be used to boost charge speed and run-time for the power station. Propane fuel can be used to produce charge electricity (by converting the energy produced from the combustion of propane) which is used to recharge the internal battery capacity of the power station. In this non-limiting embodiment, the solar panels can be used to recharge the power station during the day (when optimal sunlight is available) and the power station can automatically initiate recharging from propane fuel when adequate sunlight is not available (e.g., based on weather or during use at night). The power station can be sized to utilize one or more solar panels or one or more propane tanks for extended power outages. Device run-time may be highly dependent on the rate of the power station discharge along with the rate of charge.

The power station may include a single storage device to store energy produced/received by the hybrid solar/propane system. The storage device may be a single energy module or multiple energy modules.

When using multiple energy modules, the individual modules may vary in size, e.g., 1000 Wh, 2000 Wh or 3000 Wh, with a combined capacity of 10,000 Wh (or more). The individual modules may be the same size or have different sizes.

When multiple energy modules are used to either supply energy or receive energy, the individual modules may be used simultaneously or sequentially. For example, when supplying power, the modules may be used one-at-time (“round robin”) in a given order (e.g., largest to smallest, etc.) and when charging, the modules may be provided energy in an additive manner such that all the modules are charged at the same time. In some cases, individual modules may be isolated from the other modules, for example, once a small sized module has been fully charged it may be removed so that the energy may be directed to other modules.

Additionally, the modules may use the same energy storage technology, e.g., lithium-based batteries, or a combination of different energy storage technologies.

As one example, a lithium-based power station may have an internal battery capacity of a certain size (Wh capacity), and can be charged in several different ways (e.g., using a power grid through an AC Power Cord, DC Power Cord, Solar Panels, USB-C input port, a connection to an EV charging station/interface, etc.). For off-grid applications, the power station can be charged via the use of one or more solar panels.

During normal power station use, the internal battery may be discharged when one or more devices are connected to the power station output ports (e.g., AC outputs, DC outputs, USB outputs, etc.). The rate of discharge will vary based on the type and quantity of devices connected.

The power station may include various output ports and/or connections for output. These ports may be used for interconnectivity between modules to allow for system level power (input and/or output) distribution and control. These connections and interconnections may allow batteries, inverters, and/or plug modules to be mixed in any order.

Additionally, different ports may be used for alternative charging options, such as, fast charging in, or various output ports (such as 120V NEMA 5-20, 120V 30 A, 240V, USB A, USB C, various DC ports, etc.). The power station, for example, using a build-in or remote controller, may detect which ports are being used and may limit the maximum output power accordingly, e.g., by reducing an output power supply to one port or by limiting maximum output power to one or more ports, so as to prevent unsafe operation. In some cases, the power station may deactivate a port entirely.

The power station may also include one or more inverters or energy conversion devices. These devices may be configured to convert energy from one type or format, e.g., Direct Current (DC) energy, to another, e.g., Alternating Current (AC). The power system may include separable modules such as to provide AC ports. This allows the number and types of ports to be expanded (or reduced) and the power station customized for a given situation. When using inverters, the inverters may be provided in multiple sizes (e.g., 6000 W or 12000 W) and can be stacked and shared. When multiple inverters or energy conversion devices are present, the power station may use them either in parallel, for example, for additional current, or in series, for example, for higher total voltage.

In some, non-limiting embodiments, the power station includes an integrated voltage conversion circuit. This may include integrated or connectorized clamps to convert the available DC battery voltage to provide a 12V port to charge or jump start a 12V vehicle.

In another, non-limiting embodiments, the power station includes an electric vehicle (EV) interface. The interface can provide fast charging and/or communication compatible various EV systems. For example, the power station can provide a fast charging such as 6.6 KW option via a SAE J1772 (EV charger) port. Additionally, the power station can be recharged using an EV charger.

Lithium-based power stations typically provide the ability to be charged and discharged simultaneously. The simultaneous charging of the power station during use allows a longer run-time for connected devices. For off-grid scenarios specifically, solar panels will allow the power station to be charged when the solar panels are connected and placed in direct sunlight. However, the charging speed from the solar panels will be highly dependent on the weather, solar angle and solar radiation. Similarly, a wind turbine (or an array of multiple turbines) allows the power station to be charged when adequate wind is available. However, the charging speed may be highly dependent on the weather and location of the wind turbine. This can limit how quickly the internal battery capacity of the power station is recharged.

An eco-friendly hybrid renewable energy system can boost charge speed and run-time for the power station. Alternative fuels such as renewable propane can be used to produce charge electricity (by converting the energy produced from the combustion of propane) which is used to recharge the internal battery capacity of the power station. The solar panels can recharge the power station during the day (when optimal sunlight is available) and the power station can automatically initiate recharging from propane fuel when adequate sunlight is not available (e.g., based on weather or during use at night). The power station can be sized to utilize one or more solar panels or one or more propane tanks that can be used for extended power outages.

Device run-time is dependent on the rate of the power station discharge along with the rate of charge. By carefully balancing the use of energy collectors, such as solar panels and wind turbines, and energy generators, such as a propane fuel generator, the use of fuel can be minimized while continuing to meet the demands for energy output.

The eco-friendly hybrid renewable energy system is designed to store energy from renewable solar/wind/propane sources for backup/emergency protection during grid outages. The size and portability of this solution is scalable which makes it extremely convenient for recreational or other uses whenever and wherever power is used.

The system can automatically track the power station input and output to maximize run-time and efficiency. Additionally, this allows the system to minimize or eliminate CO2 emissions. By prioritizing (or maximizing) the use of renewable energy (e.g., solar array/wind turbine) the system can reduce (or minimize) generator runtime and renewable propane usage. Furthermore, the system can track power usage in order to adjust power input based on power level forecast (e.g., to ensure sufficient energy supply from collection/generation sources to meet continued output levels). The system may also recommend capacity sizing based on demand.

The system may include a controller (or control circuit) which monitors the input and output levels as well as battery capacity in order to determine when to operate the energy generator systems. If battery capacity reaches a first threshold level (e.g., less than or equal to 50%), then the control circuit draws from the generator. Once the capacity reaches a second threshold level (optimally 100%), the control circuit can switch off from the generator automatically. Likewise, the controller can turn off the generator systems when the energy collectors begin producing more power than being output, for example, when the sun comes up. This may also be conditional upon the battery capacity being over the first threshold level (or a different, third threshold level). Additionally, the power station may be configured (such as by using a remote device) in order to adjust the thresholds based on user preference/priorities.

In some embodiments, the controller is configured to monitor the output voltage. In addition to providing information regarding the use of the system, the controller can also adjust the output voltage in order to ensure it does not exceed a given threshold limit. For example, the controller can determine and adjust the system's maximum output so as not to exceed the capacity of the attached storage device.

The controller may also include a wireless interface, such as Bluetooth, Wi-Fi, cellular, etc. This allows the system, via the controller, to be operated by remote control and/or monitored using another device.

The wirelessly connected device could be a mobile phone or computer operating an application (or app) to enable operating, configuring and monitoring of the system. The controller can also provide notification to the wirelessly connected device in given situations, e.g., when the storage power is at or below a given threshold. Monitoring could track measurable inputs including, but not limited to, input voltage, current, and power from the various sources (AC input, solar input, generator input, USB inputs, battery modules, other complete modular systems, etc.), output voltage, current and power (similar to input), and system/status indicators (exact state of operation, internal or ambient temperatures, state of input switches, or presence or state of connected or attached devices or modules, etc.). Remote control could be used to turn on or off the system, selectively turn inputs or outputs on and off, enable or disable modules or attached systems, set up push system status messages or alerts, and enable or disable remote monitoring or reporting to the manufacturer/customer support, etc.

The system can enjoy good gain efficiency by not running off generator all the time, only when needed. This provides a quick complement to the solar power for a quicker recharge boost. When charging from generator the system can maximize charge speed. The generator may naturally charge faster than the solar panels. By end of day, they system can also maximize draw from solar panels. This is done to charge the battery faster than it is being depleted or at least maintain an even balance.

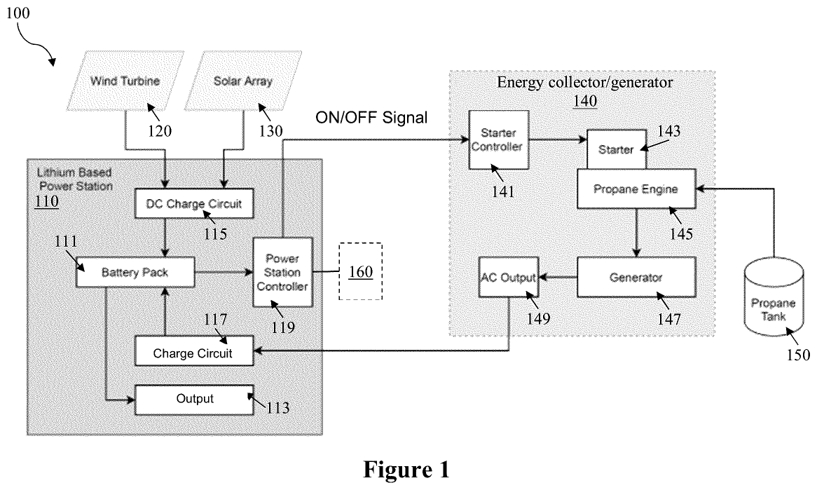

FIG. 1 schematically illustrates a power station system 100. The power station system 100 includes a lithium-based power station 110, two energy collector elements 120, 130 and a renewable propane generator 140. The lithium-based power station 110 houses a battery pack 111 and a power station controller 119. A DC charge circuit 115 connects the battery pack 111 to the collector elements 120, 130 and allow the battery pack 111 to charge based on ambient power sources. As shown here, the collector elements 120, 130 include a wind turbine 120 and a solar array 130.

A charge circuit 117 (such as, an AC charge circuit or a DC charge circuit) enables charging of the battery pack 111 from the renewable propane generator 140. An output 113 allows the power station to provide energy to connected devices. In an alternative embodiment, various output options may be included, such as a DC output, a USB port, etc.

The renewable propane generator 140 includes a starter controller 141 which can operate a starter 143 in order to start the propane engine 145. The propane engine 145, which is connected to a propane tank 150, uses propane to cause the generator 147 to create energy. This energy is provided to the AC output 149 which is connected to the charge circuit 117 of the lithium-based power station 110.

The power station controller 119 is configured to monitor the battery pack 111 and send on/off signals to the renewable propane generator 140 in order to control charging. The power station controller 119 can determine energy input to the battery pack 111 from either the DC charge circuit 115 and/or the charge circuit 117 as well determine the energy levels within the battery pack 111. Based on this information, the power station controller 119 can determine when to run the renewable propane generator 140.

The power station controller 119 may also be connected to a wireless communication interface 160. In some embodiments, this may be integrated into the power station system 100 or provided using a suitable modular device. The wireless communication interface 160 can be wired or wireless, use direct radio frequency, infrared, Bluetooth, or Wi-Fi technologies. Using the wireless communication interface 160, the controller may be operated remotely, for example, to turn it on/off, configure the system, etc. Additionally, the power station controller 119 may send information regarding the status of the power station system 110 to a remote device (such as a phone or computer).

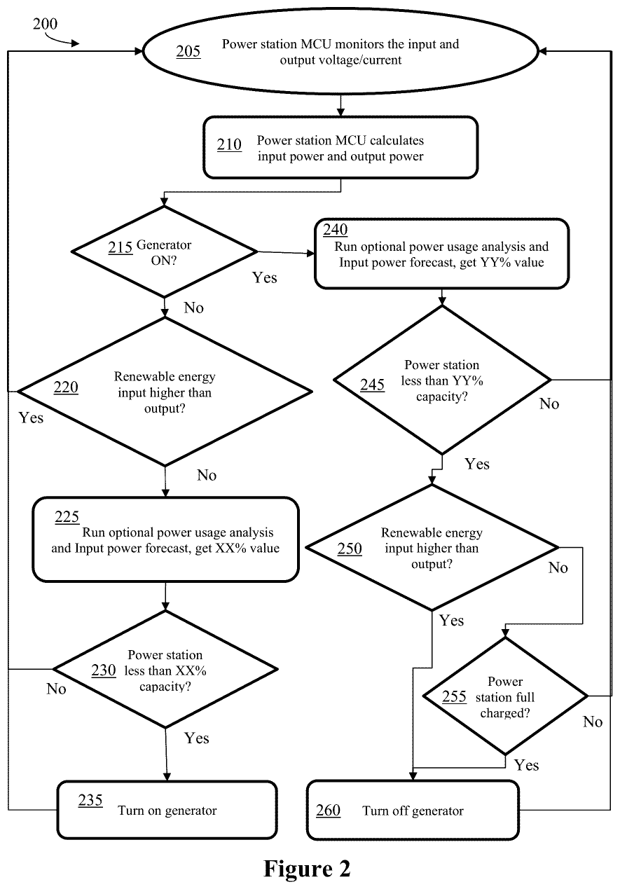

FIG. 2 shows a flowchart 200 of controlling the power station system. At step 205, the power station master control unit (MCU), such as a power station controller 119, monitors the input and output voltage/current. In some embodiments, the power station controller 119 may also respond to a control device, such as an app running on a mobile device, in order to receive instructions and/or to set priorities/behavior. The power station MCU calculates input power and output power at step 210 and determines whether the generator is ON at step 215. If the generator is off, the power station MCU moves to step 220 and checks if the renewable energy input (e.g., energy supplied by energy collector elements) is higher than output. If the input is higher than the output, the power station MCU returns to step 205 and continues to monitor the power station system.

If the energy input is lower than or equal to the output, the power station MCU proceeds to step 225 and runs power usage analysis and input power forecast to determine a target capacity value XX %. Alternatively, the power station MCU may look up a predetermined target capacity value XX %. At step 230, the power station MCU checks if the power station energy storage is less than the target capacity value XX %. If the power station energy storage is less than the target capacity value XX %, the power station MCU moves to step 235 and turns on the generator. Otherwise, the power station MCU returns to step 205 and continues to monitor the power station system.

If, at step 215, the power station MCU determines whether the generator is On, the power station MCU can run power usage analysis and Input power forecast to determine a target capacity value XX % at step 240. Alternatively, the power station MCU may look up a predetermined target capacity value YY %. Note that the values for XX % and YY % may be the same or different.

At step 245, the power station MCU checks if the power station energy storage is less than the target capacity value YY %. If not, the power station MCU returns to step 205 and continues to monitor the power station system.

When the power station energy storage is greater than (or equal to) the target capacity value YY %, the power station MCU checks to see if the renewable energy input higher than output at step 250. If the input higher than the output, the power station MCU turns off the generator at step 260.

If the input is lower than (or equal to) the output, the power station MCU determines whether the power station energy storage is full charged. If it is, it can move to step 260 and turn of the generator. Otherwise, the power station MCU returns to step 205.

Still further, the power station system is designed to connect to one or more battery expansion modules to increase battery capacity as needed. The power station includes connection means for easy mechanical connection of an expansion module. Each expansion module includes an internal rechargeable battery unit. Thus, when the expansion module is mechanically connected to the power station, the internal battery unit of the expansion module is electrically connected to the internal battery unit of the power station to provide a boost of additional power and capacity. The expansion module includes first connection means to complement the connection means on the power station.

Additionally, the expansion module may include a second connection means, simulating the connection means of the power station, so that multiple expansion modules can be connected to the power station, in series, at the same time.

In some embodiments, the power station system is provided with a USB connection port, a DC connection port, and an ignition connection port. The USB connection port can act as a power output and is used for connecting the power station with electronic devices and/or external power sources using appropriate charging cables and adapter units. In certain embodiments, multiple USB ports may be provided. Additionally, the ports may use other known connection interfaces, such as micro-USB, mini-USB, Apple Lightning™, Apple 30-pin, or the like, without departing from the spirit and principles described here.

The DC connection port can act as a power input and is used for connecting the power station system with external power sources using appropriate charging cables with AC/DC adapters. This can allow the power station system to receive energy from an alternative power source, such as a power grid. In one, non-limiting embodiment, a separate DC input and DC output may be provided.

The power station system may also include a power indicator that indicates the remaining operating status of the power station, as well as other details, such as capacity of the internal rechargeable battery unit in the power station. For example, an LCD display screen may be provided, which can provide numerous operational details for the portable power station.

The power station system may also include a controller or microprocessor, including a processing unit, configured to execute instructions and to carry out operations associated with the power station. For example, the processing unit can keep track of the capacity level of the battery unit, store data or provide a conduit means by which data can be exchanged between electronic devices, such as between a smart phone and a computer. The processing unit communicates with the battery unit to determine how much capacity is remaining in the battery. Upon determining the capacity level, the processing unit can communicate with the power indicator means to provide the user with information for how much capacity is remaining in the internal rechargeable battery unit.

In some embodiments, the processing unit can communicate with the power generating devices to determine fuel levels and provide the user with and indicator of how much fuel remains. Additionally, the processing unit may alert a user when fuel levels are low. This alert can be an audio signal, a flashing indicator or even a signal to smart phone or a computer.

In various embodiments, the power station system may include latching (or interlocking) storage devices. This would allow multiple storage devices to be combined together, for example, by stacking one atop the other, with connections enabling the storage devices to be electrically connected (e.g., independently, in series or in parallel). When connected, the power station controller may be able to recognize the individual storage devices and operate them independently or together.

The power station system may also include a frame (or exoskeleton) to support the multiple storage devices. This frame may also include additional electrical connections for the power station system, as well as physical components, such as, handles, wheels, cooling fins, etc.

In some embodiments, the frame can provide a connection (and securing) point for additional modules, such as, solar panels, a hydroelectric generator, lights, etc. The frame can be designed to accommodate a specific number of modules and/or provide attachment points for expanding the number of modules and the size of frame accordingly.

In embodiments, control circuitry may keep track of the capacity level of the battery unit, store data or provide a conduit means by which data can be exchanged between electronic devices, such as between a smart phone and a computer. The control circuitry may also communicate with the battery unit to determine how much capacity is remaining in the battery. Upon determining the capacity level, the processing unit may communicate with the power indicator means to provide the user with information for how much capacity is remaining in the internal rechargeable battery unit.

In one, non-limiting embodiment, a power station system is provided. The power station system includes one or more energy collector configured to collect energy from an associated ambient source, e.g., a solar panel array configured to capture energy from sunlight, a hydro collector (or hydroelectric generator) configured to generate energy from moving water, etc. The power station system also includes one or more energy generators configured to create energy, e.g., propane generators. An energy storage is provided to store energy from the one or more energy collectors and the one or more energy generators and one or more output connections provide energy, e.g., an AC outlet. The power station system has a controller configured to determine input power based on energy collected by the one or more energy collectors and energy generated by the one or more energy generators. The controller can determine output power based on the energy provided to the one or more energy output connections and control the one or more energy generators based on the input power and the output power.

In a further embodiment of the power station system above, when controlling the one or more energy generators, the controller is further configured to determine whether the energy storage has a threshold percentage of capacity. The controller can further be configured to turn off the one or more energy generators in response to the energy storage exceeding the threshold percentage of capacity. The controller may also turn on the one or more energy generators in response to the energy storage being less than the threshold percentage of capacity.

In an additional embodiment of any one of the power station systems above, when controlling the one or more energy generators, the controller is further configured to determine whether the input power exceeds the output power. The controller can be further configured to turn off the one or more energy generators in response to the input power exceeding the output power.

In a further embodiment of any one of the power station systems above, the one or more energy collectors comprises a solar panel and/or a wind turbine.

In an additional embodiment of any one of the power station systems above, the one or more energy generators comprises one or more propane generators.

In a further embodiment of any one of the power station systems above, the one or more output connections comprises an AC connection, a DC connection and/or a USB connection.

In an additional embodiment of any one of the power station systems above, the power station system is configured to simultaneously provide energy and store energy.

In a further embodiment of any one of the power station systems above, the energy storage comprises one or more lithium-based batteries.

A further embodiment provides a controller for a power station system. The power station system has at least one energy collector, at least one energy generator, an energy storage and at least one output port. The controller includes at least one processor; and at least one memory storing computer program code. The at least one memory and the computer program code are configured to, with the at least one processor, cause the controller to determine input power based on energy collected by the at least one energy collector and energy generated by the at least one energy generator, to determine output power based on the energy provided to the at least one energy output connection and to control the at least one energy generator based on the input power and the output power.

In an additional embodiment of the controller above, when controlling the at least one energy generator, the controller is further configured to determine whether the energy storage has a threshold percentage of capacity. The controller can turn off the at least one energy generator in response to the energy storage exceeding the threshold percentage of capacity and/or the controller is further configured to turn on the at least one energy generator in response to the energy storage being less than the threshold percentage of capacity.

In a further embodiment of any one of the controllers above, when controlling the at least one energy generator, the controller is further configured to determine whether the input power exceeds the output power. The controller may also turn off the at least one energy generator in response to the input power exceeding the output power.

In an additional embodiment of any one of the controllers above, the controller is embodied in an integrated circuit.

In a further embodiment of any one of the controllers above, the at least one memory is a storage medium.

In another embodiment of any one of the controllers above, the at least one memory is a non-transitory computer readable medium (e.g., CD-ROM, RAM, flash memory, etc.).

Any of the operations described that form part of the presently disclosed embodiments may be useful machine operations. Various embodiments also relate to a device or an apparatus for performing these operations. The apparatus can be specially constructed for the required purpose, or the apparatus can be a general-purpose computer selectively activated or configured by a computer program stored in the computer. In particular, various general-purpose machines employing one or more processors coupled to one or more computer readable medium, described below, can be used with computer programs written in accordance with the teachings herein, or it may be more convenient to construct a more specialized apparatus to perform the required operations.

The procedures, processes, and/or modules described herein may be implemented in hardware, software, embodied as a computer-readable medium having program instructions, firmware, or a combination thereof. For example, the functions described herein may be performed by a processor executing program instructions out of a memory or other storage device.

The foregoing description has been directed to particular embodiments. However, other variations and modifications may be made to the described embodiments, with the attainment of some or all of their advantages. Modifications to the above-described systems and methods may be made without departing from the concepts disclosed herein. Accordingly, the invention should not be viewed as limited by the disclosed embodiments. Furthermore, various features of the described embodiments may be used without the corresponding use of other features. Thus, this description should be read as merely illustrative of various principles, and not in limitation of the invention.

Wwhat is claimed is:

1. A power station system comprising:
at least one energy collector configured to collect energy from an associated ambient source;
at least one energy generator configured to create energy;
at least one energy storage device configured to store energy from the at least one energy collector and the at least one energy generator;
at least one inverter or energy conversion device configured to convert energy from one type or format to another;
at least one output port configured to provide energy; and
a controller configured:
to determine input power based on energy collected by the at least one energy collector and energy generated by the at least one energy generator,
to determine output power based on the energy provided to the at least one energy output connection and
to control the at least one energy generator based on the input power and the output power.

2. The power station system as in claim 1, wherein, when controlling the at least one energy generator, the controller is further configured to determine whether the at least one energy storage device has a threshold percentage of capacity.

3. The power station system as in claim 2, wherein the controller is further configured to turn off the at least one energy generator in response to the at least one energy storage device exceeding the threshold percentage of capacity.

4. The power station system as in claim 2, wherein the controller is further configured to turn on the at least one energy generator in response to the at least one energy storage device being less than the threshold percentage of capacity.

5. The power station system as in claim 1, wherein the at least one inverter or energy conversion device comprises a plurality of inverter or energy conversion devices configured to work either in parallel or in series with each other.

6. The power station system as in claim 1, wherein the at least one energy storage device comprises a plurality of storage devices configured for one of:
simultaneous energy storage, and
sequential energy storage where each is sequentially depleted.

7. The power station system as in claim 1, wherein, when controlling the at least one energy generator, the controller is further configured to determine whether the input power exceeds the output power.

8. The power station system as in claim 7, wherein the controller is further configured to turn off the at least one energy generator in response to the input power exceeding the output power.

9. The power station as in claim 1, wherein, when controlling the at least one energy conversion device, the controller is further configured to determine and adjust maximum output so as not to exceed a capacity of the at least one energy storage device.

10. The power station system as in claim 1, wherein the at least one energy collector comprises at least one of: a solar panel, a hydro collector, and a wind turbine.

11. The power station system as in claim 1, wherein the at least one energy generator comprises at least one propane generator.

12. The power station system as in claim 1, further comprising at least one input port configured to receive energy from an external source, the at least one input port comprising at least on of: an AC connection, a DC connection and a USB connection.

13. The power station system as in claim 1, wherein the at least one output port comprises at least on of: an AC connection, a DC connection and a USB connection.

14. The power station system as in claim 1, wherein the power station system is configured to simultaneously provide energy and store energy.

15. The power station system as in claim 1, wherein the at least one energy storage device comprises at least one lithium-based battery.

16. The power station system as in claim 1, wherein the power station system is one of: a modular power station system and a stand-alone power station system.

17. The power station system as in claim 1, wherein the controller is configured to deactivate individual output ports of the at least one output port in order to, at least one of: limit output power; and maintain safe operation within individual port capacity or a capacity of the at least one inverter or energy conversion device.

18. The power station system as in claim 1, further comprising at least one connector configured to enable modular connection and interconnection of the power station system, without respect to the assembly order and without user intervention to enable safe and proper operation.

19. The power station system as in claim 1, further comprising:
an integrated voltage conversion circuit configured to convert energy stored in the at least one energy storage device in order to power a 12 V port to charge or jump start a 12V vehicle;
appropriate safety circuitry for the integrated voltage conversion circuit; and
a connector having clamps to connect to the vehicle.

20. The power station system as in claim 1, further comprising a wireless communication element configured to enable remote operation and monitoring of the controller.

21. The power station system as in claim 1, further comprising a fast-charging interface enabling operation and communication with electric vehicle (EV) chargers.

22. A controller for a power station system, the power station system having at least one energy collector, at least one energy generator, at least one energy storage device , at least one inverter or energy conversion device and at least one output port, the controller comprising at least one processor; and at least one memory including computer program code, the at least one memory and the computer program code configured to, with the at least one processor, cause the controller to perform at least the following:
to determine input power based on energy collected by the at least one energy collector and energy generated by the at least one energy generator,
to determine output power based on the energy provided to the at least one energy output connection and
to control the at least one energy generator based on the input power and the output power.

23. The controller as in claim 22, wherein, when controlling the at least one energy generator, the controller is further configured to determine whether the at least one energy storage device has a threshold percentage of capacity.

24. The controller as in claim 23, wherein the controller is further configured to turn off the at least one energy generator in response to the at least one energy storage device exceeding the threshold percentage of capacity.

25. The controller as in claim 23, wherein the controller is further configured to turn on the at least one energy generator in response to the at least one energy storage device being less than the threshold percentage of capacity.

26. The controller as in claim 22, wherein, when controlling the at least one energy generator, the controller is further configured to determine whether the input power exceeds the output power.

27. The controller as in claim 26, wherein the controller is further configured to turn off the at least one energy generator in response to the input power exceeding the output power.

28. The controller as in claim 22, wherein the controller is embodied in an integrated circuit.

29. The controller as in claim 22, wherein the at least one energy storage device comprises a plurality of storage devices configured for one of:
simultaneous energy storage, and
sequential energy storage where each is sequentially depleted.

30. The controller as in claim 1, wherein, when controlling the at least one energy conversion device, the controller is further configured to determine and adjust maximum output so as not to exceed a capacity of the at least one energy storage device.

31. The controller as in claim 22, wherein the controller is configured to deactivate individual output ports of the at least one output port in order to, at least one of: limit output power; and maintain safe operation within individual port capacity or a capacity of the at least one inverter or energy conversion device.

32. The controller as in claim 22, wherein the controller is configured to communicate with a wireless interface to enable remote operation and monitoring of the controller.
